(19) United States
(12) Patent Application Publication
(10) Pub. No.: US 2017/0359482 A1
(43) Pub. Date: Dec. 14, 2017

(54) PROCESSING SYSTEM, INFORMATION PROCESSING APPARATUS, AND PROCESSING APPARATUS

(71) Applicant: FUJI XEROX CO., LTD., Tokyo (JP)

(72) Inventor: Shigehiko SASAKI, Kanagawa (JP)

(73) Assignee: FUJI XEROX CO., LTD., Tokyo (JP)

(21) Appl. No.: 15/366,656

(22) Filed: Dec. 1, 2016

(30) Foreign Application Priority Data
Jun. 9, 2016 (JP) 2016-115372

(51) Int. Cl. H04N 1/32; H04N 1/00

(52) U.S. Cl. CPC H04N 1/32545; H04N 1/32539; H04N 1/00973; H04N 1/32678

(57) ABSTRACT

A processing system includes an acceptance unit, a first transmission unit, an obtaining unit, and a second transmission unit. The acceptance unit accepts an instruction for performing a process. The first transmission unit transmits the instruction to a processing apparatus. The obtaining unit obtains identification information for identifying a substitute apparatus that performs at least a portion of the process indicated by the transmitted instruction on behalf of the processing apparatus. The second transmission unit transmits the instruction accepted by the acceptance unit to the substitute apparatus by using the identification information in a case where the identification information has been obtained.

### CROSS-REFERENCE TO RELATED APPLICATIONS

This application is based on and claims priority under 35 USC 119 from Japanese Patent Application No. 2016-115372 filed Jun. 9, 2016.

### BACKGROUND

### Technical Field

The present invention relates to a processing system, an information processing apparatus, and a processing apparatus.

### SUMMARY

According to an aspect of the invention, there is provided a processing system including an acceptance unit, a first transmission unit, an obtaining unit, and a second transmission unit. The acceptance unit accepts an instruction for performing a process. The first transmission unit transmits the instruction to a processing apparatus. The obtaining unit obtains identification information for identifying a substitute apparatus that performs at least a portion of the process indicated by the transmitted instruction on behalf of the processing apparatus. The second transmission unit transmits the instruction accepted by the acceptance unit to the substitute apparatus by using the identification information in a case where the identification information has been obtained.

### BRIEF DESCRIPTION OF THE DRAWINGS

An exemplary embodiment of the present invention will be described in detail based on the following figures, wherein:

FIG. 1 is a diagram illustrating an overall configuration of a processing system according to an exemplary embodiment;

FIG. 2 is a diagram illustrating an example configuration of a terminal;

FIG. 3 is a diagram illustrating an example configuration of a processing apparatus;

FIG. 4 is a diagram illustrating an example configuration of a substitute apparatus;

FIG. 5 is a diagram illustrating an example functional configuration of the processing system; and

FIG. 6 is a sequence chart illustrating an example operation in the processing system.

### DETAILED DESCRIPTION

### 1. Exemplary Embodiment

1-1. Overall Configuration of Processing System

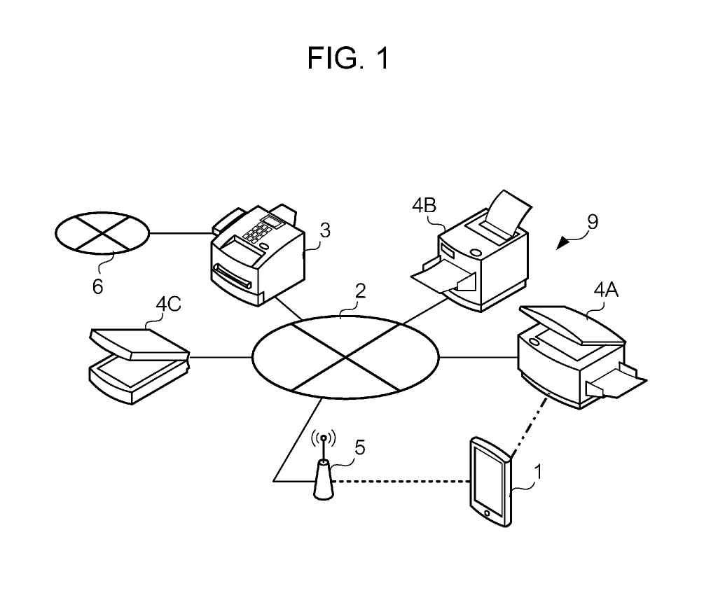

FIG. 1 is a diagram illustrating an overall configuration of a processing system 9 according to an exemplary embodiment. The processing system 9 includes a communication line 2 that constitutes a local area network (LAN), and a processing apparatus 3 and a substitute apparatus 4 that are connected to each other via the communication line 2.

Plural processing apparatuses 3 and plural substitute apparatuses 4 may be provided. In FIG. 1, the substitute apparatuses 4 are a substitute apparatus 4A, which is a copy machine, a substitute apparatus 4B, which is a printer, and a substitute apparatus 4C, which is a scanner, for example. The number and types of available functions may differ between the processing apparatus 3 and the substitute apparatuses 4; however, one or more of the substitute apparatuses 4 are able to perform at least some of the processes to be performed by the processing apparatus 3.

In FIG. 1, the processing apparatus 3 is also connected to a public telephone line 6 and has a facsimile function of transmitting image data to other apparatuses via the public telephone line 6.

The processing system 9 includes a terminal 1 that accepts an instruction given by a user for causing the processing apparatus 3 to perform a process. The terminal 1 is configured to make a connection with the processing apparatus 3 and with the substitute apparatuses 4 via a wireless access point 5 that is connected to the communication line 2. The wireless access point 5 provides a function of connecting the terminal 1 with the communication line 2 in accordance with a scheme compliant with a wireless LAN standard, such as IEEE 802.11, for example.

One or more of the substitute apparatuses 4 may have a function of making a connection with the terminal 1 in accordance with a scheme compliant with a near field communication (NFC) standard, such as ISO/IEC 18092 (NFCIP-1), ISO/IEC 14443, ISO/IEC 15693, or IEEE 802.15, for example. In the example illustrated in FIG. 1, the substitute apparatus 4A makes a connection with the terminal 1 in accordance with a scheme compliant with an NFC standard and exchanges identification information for identifying the substitute apparatus 4A and other information on the LAN constituted by the communication line 2, for example.

### 1-2. Configuration of Terminal

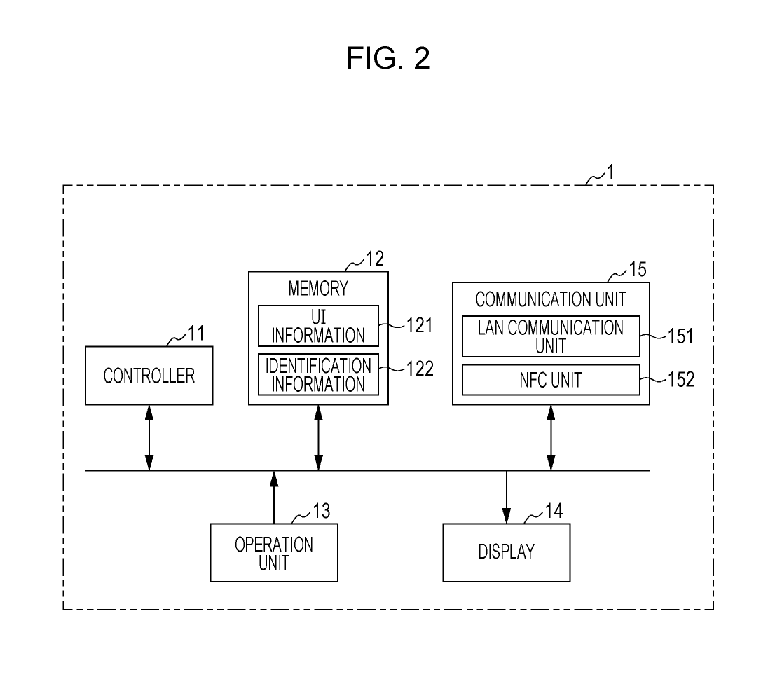

FIG. 2 is a diagram illustrating an example configuration of the terminal 1. The terminal 1 is an example of an acceptance apparatus that accepts an instruction for causing the processing apparatus 3 to perform a process, and is an example of an information processing apparatus that performs information processing so as to cause an apparatus to perform the process indicated by the accepted instruction. The terminal 1 includes a controller 11, a memory 12, an operation unit 13, a display 14, and a communication unit 15.

The controller 11 includes a central processing unit (CPU), a read-only memory (ROM), and a random access memory (RAM) and controls each unit in the terminal 1 by the CPU loading and executing a computer program (hereinafter simply referred to as a program) stored in the ROM or in the memory 12.

The operation unit 13 includes an operation device, such as operation buttons or a touch panel, for inputting various instructions, accepts an operation performed by a user, and supplies a signal corresponding to the details of the operation to the controller 11.

The display 14 includes a liquid crystal display and displays various types of information as instructed by the controller 11. On the liquid crystal display of the display 14, the touch panel of the operation unit 13 may be stacked and disposed. In this case, the touch panel is formed of a transparent material so that the user is able to see an image displayed on the liquid crystal display of the display 14.

The memory 12 is a bulk memory, such as a solid state drive, and stores the program loaded by the CPU of the controller 11. The memory 12 further stores user interface (UI) information 121 and identification information 122, as illustrated in FIG. 2.

The program described above may be divided into an operating system (OS), which is a base program, and an application program (application), for example. In this case, the OS, which is a base program, directly controls operations performed by the controller 11, the memory 12, the operation unit 13, the display 14, and the communication unit 15 of the terminal 1, and the application, which is an application program, is executed under the control of the OS and may cause each unit of the terminal 1 to perform operations via the OS.

The UI information 121 is, for example, information about an operation screen transmitted from the processing apparatus 3 via the communication line 2 and via the wireless access point 5 and is information that represents a UI for giving an instruction to the processing apparatus 3. In the terminal 1, the display 14 displays an operation screen for operating the processing apparatus 3 by using the UI information 121 stored in the memory 12, and the operation unit 13 accepts an instruction given by the user for causing the processing apparatus 3 to perform a process.

The identification information 122 is, for example, information transmitted from one of the substitute apparatuses 4 via NFC and is information for identifying the substitute apparatus 4 on the LAN constituted by the communication line 2. The terminal 1 identifies the substitute apparatus 4 by using the identification information 122.

The communication unit 15 includes a LAN communication unit 151 and an NFC unit 152. The LAN communication unit 151 is a communication circuit for making a connection with the communication line 2 via the wireless access point 5. The NFC unit 152 is a communication circuit for making a connection with one of the substitute apparatuses 4 in accordance with a scheme compliant with an NFC standard.

### 1-3. Configuration of Processing Apparatus

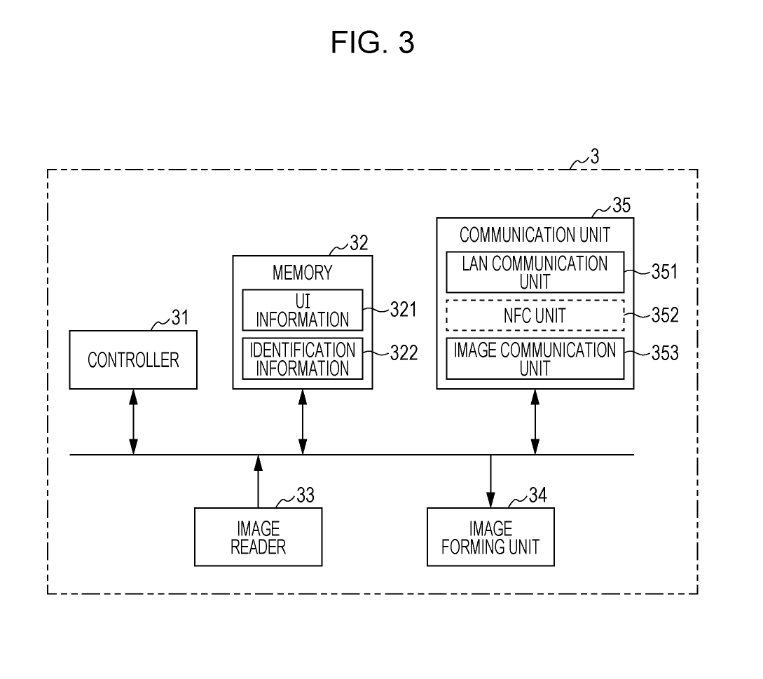

FIG. 3 is a diagram illustrating an example configuration of the processing apparatus 3. The processing apparatus 3 includes a controller 31, a memory 32, an image reader 33, an image forming unit 34, and a communication unit 35. The controller 31 includes a CPU, a ROM, and a RAM and controls each unit in the processing apparatus 3 by the CPU loading and executing a program stored in the ROM or in the memory 32.

The memory 32 is a bulk memory, such as a hard disk drive, and stores the program loaded by the CPU of the controller 31. The memory 32 further stores UI information 321 and identification information 322. The UI information 321 is original information about an operation screen that is transmitted to the terminal 1 for display, and is information that represents a UI used on the terminal 1 to give an instruction to the processing apparatus 3. The identification information 322 is information about one of the substitute apparatuses 4 that is identified on the basis of identification information that the terminal 1 exchanges with the substitute apparatus 4.

The communication unit 35 includes a LAN communication unit 351, an NFC unit 352, and an image communication unit 353. The LAN communication unit 351 is a communication circuit for making a wired or wireless connection with the communication line 2. The NFC unit 352 is a communication circuit for making a connection with the terminal 1 in accordance with a scheme compliant with an NFC standard. The image communication unit 353 is a communication circuit for making a connection with other apparatuses via the public telephone line 6 and for transmitting and receiving image data. Note that the processing apparatus 3 need not include the NFC unit 352.

The image reader 33 is a unit that optically reads a document. The image reader 33 includes an image sensor, such as a charge-coupled device (CCD) image sensor, and generates image data that represents a document. The image reader 33 may be a flat-bed-type image sensor that reads a document while moving its image sensor, a sheet-feed-type image sensor that reads a document while moving the document without changing the position of its image sensor, or an image reader of another type.

The image forming unit 34 is a unit that forms an image on the basis of image data. The image forming unit 34 forms an image on a sheet in accordance with an electrophotographic system or a thermal transfer system, for example.

### 1-4. Configuration of Substitute Apparatus

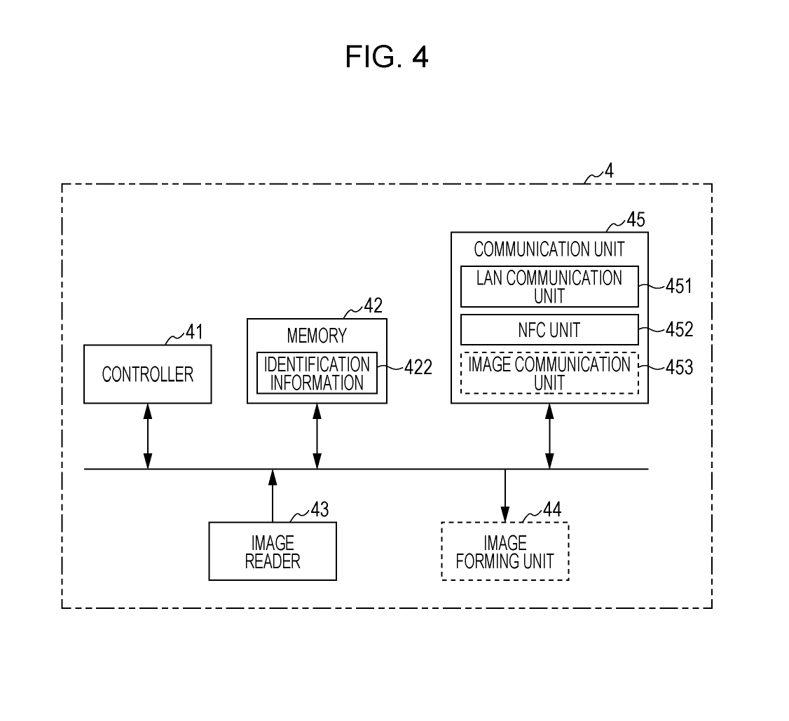

FIG. 4 is a diagram illustrating an example configuration of the substitute apparatus 4. The substitute apparatus 4 includes a controller 41, a memory 42, an image reader 43, an image forming unit 44, and a communication unit 45. The controller 41 includes a CPU, a ROM, and a RAM and controls each unit in the substitute apparatus 4 by the CPU loading and executing a program stored in the ROM or in the memory 42.

The memory 42 is a bulk memory, such as a hard disk drive, and stores the program loaded by the CPU of the controller 41. The memory 42 further stores identification information 422. The identification information 422 is information for identifying the substitute apparatus 4 itself on the LAN constituted by the communication line 2 and is information that is transmitted to the terminal 1 via NFC. The identification information 422 includes an Internet Protocol (IP) address, for example.

The communication unit 45 includes a LAN communication unit 451, an NFC unit 452, and an image communication unit 453. The LAN communication unit 451 is a communication circuit for making a wired or wireless connection with the communication line 2. The NFC unit 452 is a communication circuit for making a connection with the terminal 1 in accordance with a scheme compliant with an NFC standard. The image communication unit 453 is a communication circuit for making a connection with other apparatuses via the public telephone line 6 and for transmitting and receiving image data. Note that the substitute apparatus 4 need not include the NFC unit 452.

The image reader 43 is a unit that optically reads a document. The image reader 43 includes an image sensor, such as a CCD image sensor, and generates image data that represents a document. The image reader 43 may be a flat-bed-type image sensor that reads a document while moving its image sensor, a sheet-feed-type image sensor that reads a document while moving the document without changing the position of its image sensor, or an image reader of another type.

The image forming unit 44 is a unit that forms an image on the basis of image data. The image forming unit 44 forms an image on a sheet in accordance with an electrophotographic system or a thermal transfer system, for example.

Note that the substitute apparatus 4 performs at least a portion of a process indicated by an instruction given by a user on behalf of the processing apparatus 3 by using the image reader 43, the image forming unit 44, and the image communication unit 453; however, the substitute apparatus 4 may have a different configuration or need not include one or more of the image reader 43, the image forming unit 44, and the image communication unit 453.

For example, the substitute apparatus 4 illustrated in FIG. 4 is the substitute apparatus 4C described above and includes the image reader 43; however, the substitute apparatus 4 illustrated in FIG. 4 does not include the image forming unit 44 and the image communication unit 453 outlined by a broken line in FIG. 4. Therefore, the substitute apparatus 4C has a function of optically reading a document and generating image data that represents the document but does not have a function of forming an image on a sheet on the basis of the image data in accordance with an electrophotographic system, for example. Further, the substitute apparatus 4C does not have a function of transmitting the generated image data to another apparatus via the public telephone line 6.

### 1-5. Functional Configuration of Processing System

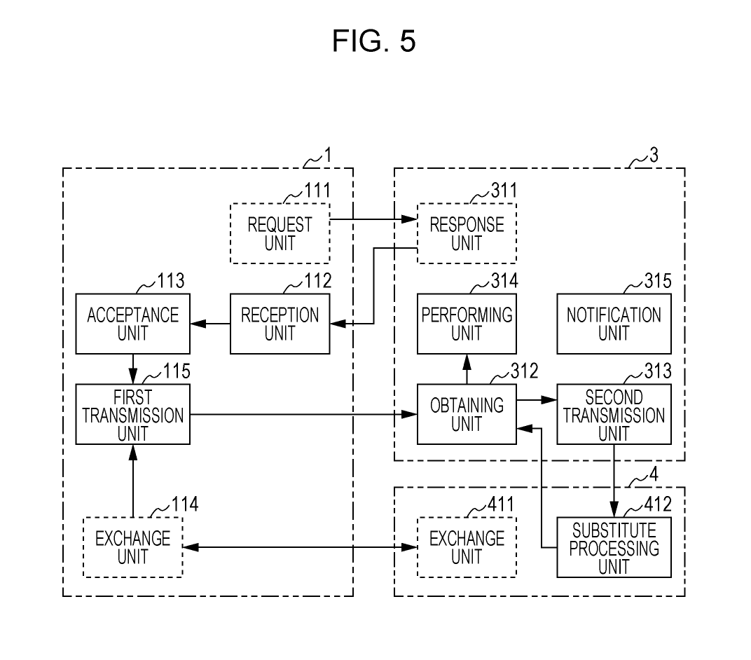

FIG. 5 is a diagram illustrating an example functional configuration of the processing system 9. The terminal 1 functions as a request unit 111, a reception unit 112, an acceptance unit 113, an exchange unit 114, and a first transmission unit 115 in accordance with control by the controller 11.

The processing apparatus 3 functions as a response unit 311, an obtaining unit 312, a second transmission unit 313, and a performing unit 314 in accordance with control by the controller 31.

The substitute apparatus 4 functions as an exchange unit 411 and a substitute processing unit 412 in accordance with control by the controller 41.

Note that, in the example illustrated in FIG. 5, the processing system 9 is a system that includes the terminal 1 including the acceptance unit 113 (acceptance unit) and the first transmission unit 115 (first transmission unit), and the processing apparatus 3 including the obtaining unit 312 (obtaining unit) and the second transmission unit 313 (second transmission unit).

The request unit 111 makes a request for the UI information 321 that represents an operation screen to the processing apparatus 3. The response unit 311 reads the UI information 321 from the memory 32, encodes the UI information 321, and transmits the encoded UI information 321 to the terminal 1 that has made the request. The reception unit 112 receives the encoded UI information 321, generates the UI information 121, which is a duplicate of the UI information 321, and stores the UI information 121 in the memory 12 (see FIG. 2).

The acceptance unit 113 generates an operation screen on the basis of the UI information 121 stored in the memory 12, displays the operation screen on the display 14 (see FIG. 2), and accepts an instruction given by a user for performing a process from the operation unit 13 (see FIG. 2).

The exchange unit 114 of the terminal 1 and the exchange unit 411 of the substitute apparatus 4 establish an NFC channel. The exchange unit 114 receives the identification information 422 of the substitute apparatus 4 on the LAN constituted by the communication line 2. The exchange unit 114 stores the identification information 122, which is a duplicate of the identification information 422, in the memory 12 (see FIG. 2).

Note that the exchange unit 114 may transmit identification information (not illustrated) for identifying the terminal 1 on the LAN constituted by the communication line 2 to the substitute apparatus 4. That is, the exchange unit 114 and the exchange unit 411 may exchange the identification information of the terminal 1 and that of the substitute apparatus 4 with each other.

The first transmission unit 115 transmits an instruction accepted by the acceptance unit 113 to the processing apparatus 3. At this time, the first transmission unit 115 transmits the identification information 122 stored in the memory 12 after reception by the exchange unit 114 to the processing apparatus 3 together with the instruction described above. Note that the terminal 1 and the substitute apparatus 4 need not have an established NFC channel at the time point when the first transmission unit 115 transmits the identification information 122 to the processing apparatus 3.

The obtaining unit 312 of the processing apparatus 3 obtains an instruction given by a user for performing a process. The obtaining unit 312 obtains the identification information 322 for identifying the substitute apparatus 4 that is to perform at least a portion of the process indicated by the instruction on behalf of the processing apparatus 3 together with the instruction. Specifically, the obtaining unit 312 generates the identification information 322, which is a duplicate of the identification information 122 transmitted from the terminal 1 together with the instruction, and stores the identification information 322 in the memory 32.

In a case where the identification information 322 has been obtained, the second transmission unit 313 transmits an instruction accepted by the acceptance unit 113 to the substitute apparatus 4 by using the identification information 322.

In response to an instruction transmitted from the processing apparatus 3, the substitute processing unit 412 performs a portion of a process indicated by the instruction, the portion of the process being able to be performed by the substitute apparatus 4, on behalf of the processing apparatus 3. When the portion of the process is completed, the substitute processing unit 412 sends a notification of completion to the processing apparatus 3.

For example, the substitute processing unit 412 controls the image reader 43 (see FIG. 4) to read an image of a document in accordance with an instruction transmitted from the processing apparatus 3 and to generate image data that represents the document. Thereafter, the substitute processing unit 412 transmits the generated image data to the processing apparatus 3 to thereby notify the processing apparatus 3 of completion of image reading performed on behalf of the processing apparatus 3.

When the processing apparatus 3 is notified by the substitute apparatus 4 of completion of the portion of the process performed by the substitute apparatus 4 on behalf of the processing apparatus 3, the performing unit 314 of the processing apparatus 3 performs the remaining portion of the process indicated by the instruction described above, the remaining portion of the process not having been performed by the substitute apparatus 4. For example, when the processing apparatus 3 receives image data together with the notification described above, the performing unit 314 transmits image data to another apparatus on the basis of the received image data via the public telephone line 6.

### 1-6. Operation in Processing System

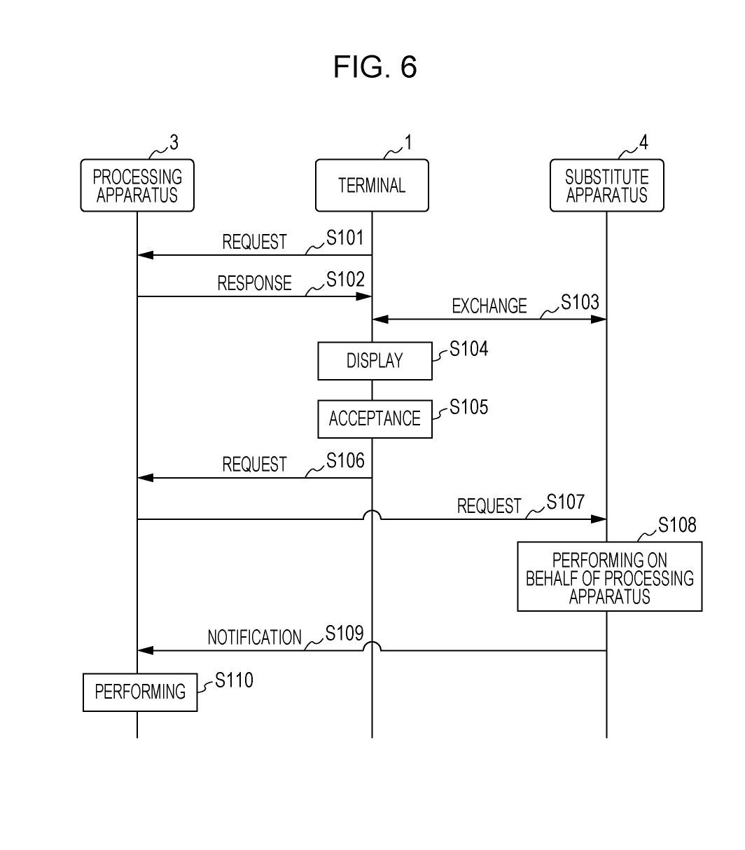

FIG. 6 is a sequence chart illustrating an example operation in the processing system 9. The terminal 1 makes a request for the UI information 321 that represents an operation screen to the processing apparatus 3 (step S101), and the processing apparatus 3 makes a response to the request (step S102). The terminal 1 exchanges identification information with one of the substitute apparatuses 4 (step S103). In this example, the terminal 1 exchanges identification information with the substitute apparatus 4A.

The terminal 1 displays an operation screen on the display 14 on the basis of the UI information 121, which is a duplicate of the UI information 321 obtained from the processing apparatus 3 (step S104). The terminal 1 accepts an instruction given by a user on the operation screen by operating the operation unit 13 (step S105).

This instruction may include plural process steps in a case of facsimile transmission, for example, namely, a first process step of reading an image of a document and generating image data and a second process step of transmitting the generated image data to another apparatus via the public telephone line 6.

The instruction also includes set values specifically set by the user of the terminal 1 for the process described above. Specifically, the set values include the resolution and gradation for reading, selection of color or monochrome, the size of the document and an area for reading, and the telephone number of the transmission destination, for example. The instruction further includes the identification information 122, which is a duplicate of the identification information 422 obtained from the substitute apparatus 4 in step S103.

When the terminal 1 accepts the instruction, the terminal 1 transmits the instruction to the processing apparatus 3 and requests the processing apparatus 3 to perform a process indicated by the instruction (step S106). Then, the processing apparatus 3 extracts from the instruction the identification information 122 that corresponds to the identification information 422 of the substitute apparatus 4, and requests the substitute apparatus 4 identified on the basis of the identification information 122 to perform a portion of the process on behalf of the processing apparatus 3 (step S107). Specifically, the processing apparatus 3 requests the substitute apparatus 4A to perform the first process step described above on behalf of the processing apparatus 3.

The substitute apparatus 4 performs the requested first process step on behalf of the processing apparatus 3 (step S108), and sends a notification of completion to the processing apparatus 3 upon completion of the first process step (step S109). This notification includes image data generated in the first process step. When the processing apparatus 3 receives the notification, the processing apparatus 3 performs the second process step described above (step S110).

For example, the processing apparatus 3 establishes a communication channel with another apparatus via the public telephone line 6 by using the telephone number included in the instruction and transmits the image data generated by the substitute apparatus 4A to the other apparatus. Consequently, facsimile transmission to the other apparatus is completed.

In the operation performed in the processing system 9 described above, an instruction given by a user for causing the processing apparatus 3 to perform a process is transmitted to the substitute apparatus 4 to thereby cause the substitute apparatus 4 to perform the process on behalf of the processing apparatus 3. Accordingly, in a case where the user has given an instruction to the processing apparatus 3, the user need not give again the instruction to the substitute apparatus 4.

### 2. Modifications

Although the exemplary embodiment has been described above, the exemplary embodiment may be modified as follows. Further, modifications described below may be combined.

### 2-1. First Modification

In the processing system 9 according to the exemplary embodiment described above, the terminal 1 includes the acceptance unit and the first transmission unit, and the processing apparatus 3 includes the obtaining unit and the second transmission unit. A configuration including these units is not limited to the configuration having this combination. For example, the terminal 1 may include the obtaining unit and the second transmission unit in addition to the acceptance unit and the first transmission unit.

In this case, the processing apparatus 3 may determine whether an obtained instruction satisfies a predetermined condition and, if it is determined that the condition is satisfied, may send a notification of the determination to the terminal 1. When the terminal 1 receives the notification from the processing apparatus 3, the terminal 1 may obtain identification information for identifying the substitute apparatus 4 that is to perform at least a portion of a process indicated by the instruction on behalf of the processing apparatus 3. Thereafter, the terminal 1 may transmit the instruction to the substitute apparatus 4 by using the obtained identification information.

Note that, the predetermined condition is a condition that, for example, the processing apparatus 3 is unable to start performing a process indicated by a user instruction within a predetermined time period.

The terminal 1 may include the obtaining unit and a controller in addition to the acceptance unit and the first transmission unit. That is, in a case where the terminal 1 has obtained identification information for identifying the substitute apparatus 4 that is to perform at least a portion of a process indicated by an instruction on behalf of the processing apparatus 3, the terminal 1 may perform control to give the instruction to the substitute apparatus 4 by using the identification information. Alternatively, control may be performed so as to transmit the instruction and the identification information to the processing apparatus 3, for example. In this case, the processing apparatus 3 that receives the instruction and the identification information may identify the substitute apparatus 4 and forward the instruction to the substitute apparatus 4.

Instead of the control described above, control may be performed so as to transmit identification information of the terminal 1, such as the IP address of the terminal 1 to the substitute apparatus 4, accept access from the substitute apparatus 4, and allow the substitute apparatus 4 to download the content of the instruction. Alternatively, control may be performed so as to store the content of the instruction on a server apparatus connected to the communication line 2, inform the substitute apparatus 4 of the access destination of the server apparatus, and allow the substitute apparatus 4 to download the content of the instruction.

### 2-2. Second Modification

In the exemplary embodiment described above, the process indicated by the user instruction accepted by the terminal 1 includes the first process step and the second process step (plural process steps); however, the process may include a single process step. In this case, the substitute apparatus 4 needs to perform the single process step included in the process on behalf of the processing apparatus 3.

### 2-3. Third Modification

Even in a case where a process indicated by a user instruction includes plural process steps, the substitute apparatus 4 may perform all of the process steps on behalf of the processing apparatus 3.

### 2-4. Fourth Modification

In the exemplary embodiment described above, the substitute apparatus 4A identified on the basis of identification information obtained by the processing apparatus 3 together with an instruction is caused to perform a first process step included in a process indicated by the instruction; however, one of the substitute apparatuses 4 other than the substitute apparatus 4A may be caused to perform the first process step. In a case where the processing apparatus 3 or the substitute apparatus 4A determines that the substitute apparatus 4A is unable to perform at least a portion of the process described above on behalf of the processing apparatus 3, for example, the processing apparatus 3 may newly obtain identification information for identifying one of the substitute apparatuses 4 (second apparatus) different from the substitute apparatus 4A (first apparatus). In this case, the second transmission unit, such as the second transmission unit 313, may transmit the instruction to the substitute apparatus 4 (second apparatus) by using the newly obtained identification information.

Specifically, in a case where the image reader 43 of the substitute apparatus 4A, which is a copy machine and with which the terminal 1 has exchanged identification information, is occupied by another user, for example, the substitute apparatus 4A is unable to perform within a predetermined time period the first process step of reading a document of the user that has given the instruction. In this case, the processing apparatus 3 obtains information about the use of the substitute apparatus 4A and determines whether the substitute apparatus 4A is able to perform the first process step. If the processing apparatus 3 determines that the substitute apparatus 4A is unable to perform the first process step, the processing apparatus 3 makes a request for identification information of one of the substitute apparatuses 4 different from the substitute apparatus 4A to the terminal 1.

When the terminal 1 receives the request, the terminal 1 attempts to exchange identification information with one of the substitute apparatuses 4 other than the substitute apparatus 4A. When the terminal 1 mutually exchanges identification information with the substitute apparatus 4C, which is a scanner, for example, the terminal 1 transmits the identification information for identifying the substitute apparatus 4C to the processing apparatus 3.

When the processing apparatus 3 newly obtains the identification information for identifying the substitute apparatus 4C from the terminal 1, the processing apparatus 3 transmits the instruction to the substitute apparatus 4C by using the newly obtained identification information. Accordingly, the first process step is performed by the substitute apparatus 4C on behalf of the processing apparatus 3, and image data generated by the substitute apparatus 4C is transmitted to the processing apparatus 3 and is thereafter transmitted to another apparatus via the public telephone line 6. Consequently, facsimile transmission to the other apparatus is completed.

### 2-5. Fifth Modification

In the fourth modification, the user instruction is transmitted to the substitute apparatus 4C by using the newly obtained identification information, and the first process step in the process indicated by the instruction is performed by the substitute apparatus 4C on behalf of the processing apparatus 3. In a case where it is determined after the user instruction has been transmitted to the substitute apparatus 4C that the substitute apparatus 4A identified on the basis of identification information initially obtained by the obtaining unit, such as the obtaining unit 312, is able to perform the first process step, the substitute apparatus 4A may perform the first process step on behalf of the processing apparatus 3.

In this case, the processing apparatus 3 may notify the terminal 1 of the fact that the substitute apparatus 4A becomes available for performing the first process step, for example. Here, the controller 31 of the processing apparatus 3 functions as a notification unit 315 (see FIG. 5) (notification unit) that, in a case where it is determined after the second transmission unit 313 (second transmission unit) has transmitted the user instruction to the substitute apparatus 4C (second apparatus) that the substitute apparatus 4A (first apparatus) is able to perform the process, sends a notification for notifying the user of the fact that the substitute apparatus 4A is able to perform the process. When the terminal 1 receives the notification, the terminal 1 may display the content of the notification on the display 14 for the user.

### 2-6. Sixth Modification

The program executed by the controller 11 of the terminal 1 may be provided in a state where the program is stored in a computer-readable recording medium, namely, a magnetic recording medium, such as a magnetic tape or a magnetic disk, an optical recording medium, such as an optical disc, a magneto-optical recording medium, or a semiconductor memory. It is possible to download the program via a communication line, such as the Internet. As the controller that is illustrated as the controller 11 described above, various devices other than a CPU may be used. For example, a dedicated processor is used.

### 2-7. Seventh Modification

The program for executing the above-described functions may be implemented by using the OS, which is a base program, or may be implemented by using a combination of the OS and an application, which is an application program.

### 2-8. Eighth Modification

In the exemplary embodiment described above, the terminal 1 accepts an instruction given by a user for causing the processing apparatus 3 to perform a process. However, the instruction is not limited to an instruction given by a user and may be an instruction that is considered to be given by a user in a case where a default setting is used and no instruction is explicitly given by a user.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing system comprising:
an acceptance unit that accepts an instruction for performing a process;
a first transmission unit that transmits the instruction to a processing apparatus;
an obtaining unit that obtains identification information for identifying a substitute apparatus that performs at least a portion of the process indicated by the transmitted instruction on behalf of the processing apparatus; and
a second transmission unit that transmits the instruction accepted by the acceptance unit to the substitute apparatus by using the identification information in a case where the identification information has been obtained.

2. The processing system according to claim 1, wherein
the acceptance unit and the first transmission unit are included in a terminal, and
the obtaining unit and the second transmission unit are included in the processing apparatus.

3. The processing system according to claim 1, wherein
the acceptance unit accepts the instruction for performing the process that includes a plurality of process steps, and
the second transmission unit transmits the instruction to the substitute apparatus by using the identification information in a case where the identification information has been obtained to thereby cause the substitute apparatus to perform a process step among the plurality of process steps of the process indicated by the instruction.

4. The processing system according to claim 1, wherein
the substitute apparatus is one of a plurality of apparatuses, and
in a case where the substitute apparatus identified based on the obtained identification information is a first apparatus that is determined to be unable to perform the process,
the obtaining unit newly obtains identification information for identifying a second apparatus different from the first apparatus among the plurality of apparatuses, and
the second transmission unit transmits the instruction to the second apparatus by using the identification information newly obtained by the obtaining unit.

5. The processing system according to claim 4, further comprising:
a notification unit that, in a case where the first apparatus is determined to be able to perform the process after the second transmission unit has transmitted the instruction to the second apparatus, sends a notification for notifying a fact that the first apparatus is able to perform the process.

6. An information processing apparatus comprising:
an acceptance unit that accepts, in accordance with an operation screen displayed for operating a processing apparatus, an instruction for causing the processing apparatus to perform a process;
an obtaining unit that obtains identification information for identifying a substitute apparatus that performs the process indicated by the instruction on behalf of the processing apparatus; and
a controller that performs control to use the instruction accepted by the acceptance unit as an instruction to be given to the substitute apparatus by using the identification information in a case where the identification information has been obtained.

7. The information processing apparatus according to claim 6, wherein
the controller performs control to transmit the instruction accepted by the acceptance unit to the substitute apparatus.

8. The information processing apparatus according to claim 6, wherein
the controller performs control to transmit the instruction accepted by the acceptance unit and the identification information to the processing apparatus.

9. A processing apparatus comprising:
an obtaining unit that obtains an instruction accepted by a terminal for performing a process and obtains identification information for identifying a substitute apparatus that performs at least a portion of the process indicated by the instruction on behalf of the processing apparatus; and
a second transmission unit that transmits the instruction to the substitute apparatus by using the identification information in a case where the identification information has been obtained.
